(19) United States
(12) Patent Application Publication
(10) Pub. No.: US 2001/0010426 A1
(43) Pub. Date: Aug. 2, 2001

(54) Supporting and sliding system for a piece of furniture door

(75) Inventor: Carlo Migli, Lecco (IT)

Correspondence Address: Shlesinger, Fitzsimmons & Shlesinger, 183 East Main Street, 1323 Alliance Building, Rochester, NY, 14604, US

(73) Assignee: Agostino Ferrari S.p.A.

(21) Appl. No.: 09/768,687

(22) Filed: Jan. 24, 2001

(30) Foreign Application Priority Data
Jan. 28, 2000 (IT) MI 2000 U 000049

(51) Int. Cl. E05C 19/00; E05C 21/00

(52) U.S. Cl. 292/1

(57) ABSTRACT

A supporting and sliding system for a piece of furniture door comprises a supporting and sliding assembly (13) to be fastened to the door for running, by means of a grooved wheel thereof (16), on a rail (14) which is designed to be secured to the piece of furniture. Present along the rail (14) is an undercut (17) under which a locking end (18) of a constraint element (19) projecting from the sliding assembly is positioned, which constraint element prevents the wheel from lifting from the rail to such an extent that derailment of the wheel from the rail should be caused. Advantageously, the constraint element (19) is of a resilient type and an operating lever (22) enables it to be moved away from its locking position when the assembly (13) is required to be removed from the rail (14).

### BACKGROUND OF THE INVENTION

The present invention relates to a hanging and sliding system for a door of a piece of furniture.

In the art of furniture accessories, hanging and sliding systems are known in which a slide carrying a wheel is fastened to each of the upper ends of the door, which wheel rests on a guide rail fastened to the upper surface of the piece of furniture. Generally, further guide systems of the slide type are present in the lower part of the piece of furniture and they aim at keeping the door in a vertical position during motion, but they do not perform a bearing or supporting function.

Separation of the wheel from the rest surface is inhibited by an appropriate counteraction. Usually, the upper slide of the sliding piece is provided with an adjustment system that by acting on an appropriate means enables the wheel position to be varied and ultimately both the door inclination and vertical alignment to be adjusted.

A configuration of this type poses a safety problem: the upper wheel slides on the rail while keeping its guided position by virtue of a central groove or race in the wheel which receives the rail top; a side displacement of the wheel bringing about, as a result, a derailment (or slipping off) of the latter is only possible through lifting of the door by an amount at least corresponding to the wheel groove. At all events this operation is to be allowed in order to enable dismantling of the wardrobe or cupboard door, but it is important that derailment should be prevented from taking place accidentally as a result of a violent push against the slide-stopping abutments or an obstacle opposing the normal door movement. In order to avoid this danger, in the known art insertion of mechanical stops flush with the lower door guide has been suggested so that the door cannot lift to a higher height than the wheel groove. These stops that can consist for example of a mere screw integral with the lower slide so as to react against an appropriate surface of the lower rail, must be inserted manually after the door has been set in place and must be obviously removed when the door is to be disassembled.

Manual insertion of the stops represents a first important problem of the known art, because a possible omission may not be noticed (since the door operation would be normal just the same), which will bring about the serious risk that the door should suddenly and unexpectedly derail.

In addition, the known systems have a further more general problem: sliding doors are usually provided with an adjusting system enabling the door to be moved vertically with respect to the upper bearing wheel, so that alignment of the door with the rest of the piece of furniture is allowed, working tolerances being compensated for. Taking into account the vertical door adjustment too, however is of difficult accomplishment with known slipping off-preventing means; in particular, under any condition of vertical adjustment, displacement of the door in a vertical direction should be always ensured to be limited to a lower value than the height of the upper-wheel groove and this over the whole guide length, i.e. over a path along which the distance between the upper and lower guides is variable due to the working tolerances of the piece of furniture.

It is a general aim of the present invention to eliminate the above-mentioned drawbacks by providing a hanging and sliding system for a sliding door offering sure and safe derailment-prevention features. It is a further aim to provide the system with features enabling automatic fitting of the derailment-preventing means.

### SUMMARY OF THE INVENTION

In view of the above aims, in accordance with the invention, a supporting and sliding system for a piece of furniture door has been devised which comprises a supporting and sliding assembly to be fastened to the door and a rail on which the sliding assembly runs and which is designed to be secured to the piece of furniture, the sliding assembly comprising a grooved wheel resting and running on the rail, characterised in that along the rail there is an undercut under which a locking end of a constraint element projecting from the sliding assembly is positioned, which constraint element prevents the wheel from lifting from the rail to such an extent that derailment of the wheel from the rail should be caused.

### BRIEF DESCRITPION OF THE DRAWINGS

For better explaining the innovative principles of the present invention and the advantages it offers over the known art, a possible embodiment applying the above principles will be described hereinafter by way of example, with the aid of the accompanying drawings. In the drawings:

FIG. 1 is a diagrammatic cross view of a hanging system in accordance with the invention;

FIG. 2 is a diagrammatic side view of the upper portion of the sliding system shown in FIG. 1;

FIG. 3 is a section taken along line III-III in FIG. 2 but with the device in an unlocked position.

### DETAILED DESCRIPTION OF THE INVENTION

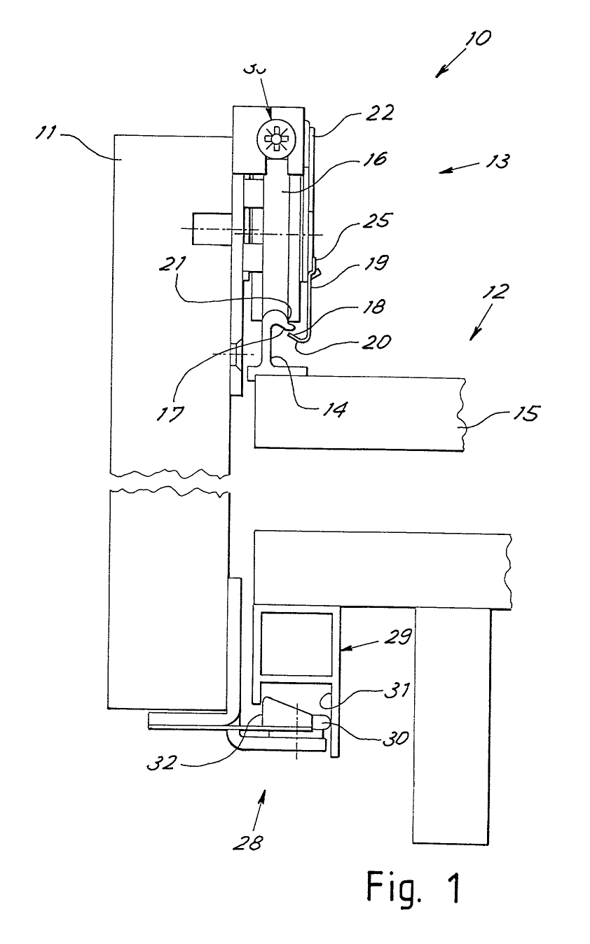

With reference to the drawings, diagrammatically shown in FIG. 1 is a supporting and sliding system (generally denoted at 10) for a door 11 of a piece of furniture 12. The system comprises a supporting and sliding assembly 13 to be fastened to the door for running on a rail which is designed to be secured to the upper surface 15 of the piece of furniture.

The sliding assembly 13 comprises a grooved wheel resting and running on the rail 14. Present on rail 14 is an undercut 17 under which a locking end 18 of a constraint element 19 projecting downwardly from the sliding assembly 13 is positioned. The locking end 18 of the constraint element is at a lower position than the undercut by a less amount than the height of the wheel groove in which the rail fits, in order to prevent the wheel from lifting from the rail so much that derailment of the wheel from the rail should be caused.

Advantageously, the constraint element 19 is elastically movable outwardly of the undercut to be snap-fitted under the undercut when the wheel is set on the rail. To enable such a snap-fitting movement, the constraint element end 18 is formed with a cam surface 20 which, when the wheel is in place on the rail, is intended to run on a corresponding cam surface 21 present on top of the undercut.

As clearly viewed from the figures, to enable its elastic movement the constraint element is advantageously made of a resilient metal foil laterally applied to the sliding assembly, and the locking end 18 is obtained by hook-wise bending the lower edge of the foil towards the rail.

Yet advantageously, the sliding assembly 13 is provided with operation means 22 to manually move the constraint element 19 outwardly of the undercut, so as to allow an easy and quick release of the assembly from the rail when required.

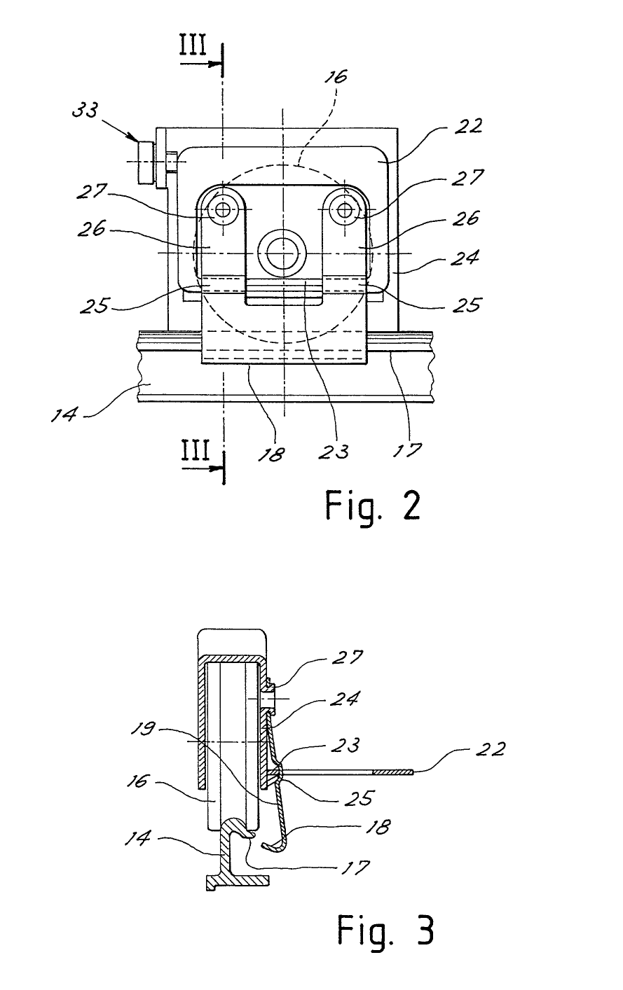

As can be seen in FIG. 2, the operation means comprises a lever 22 which is movable between a rest position (parallel to the foil) and a work position (directed outwardly). As shown in FIG. 3, in the work position the lever moves the constraint element outwardly of the undercut. To obtain this, lever 22 has a cam surface 23 extending between the foil 19 and a facing underlying surface 24 of the sliding assembly. Advantageously, the cam surface is received in shaped seatings 25 formed in foil 19, so as to keep the lever in place and give it a preestablished rotation seating. The lever can be obtained in an inexpensive manner merely as an element cut from a plate and inserted under the resilient foil 19 with a plate strip 23 thereof which is disposed parallel to the rail to be received in the shaped seatings and form the cam surface moving the resilient foil apart when the lever is operated towards its work position. The elastic thrust itself of foil 19 usually keeps the lever to the rest position. As shown in FIG. 2, the lever can be cut into a rectangular shape and be provided with a conveniently-sized rectangular hole so that it matches the external outline of the resilient foil with a minimum clearance.

As still viewed from FIG. 2, the resilient foil is formed with a pair of bending arms 26, fastened at one end to the sliding assembly (by riveting 27 for example). The seatings 25 for the operating lever are made in these bending arms.

As shown in FIG. 1, system 10 may also comprise a guide and slide assembly 28 to be fastened to door 11 close to a lower side thereof to run along a second rail 29 secured to the piece of furniture parallel to the first rail 14. Since the bearing function is accomplished by the upper wheel 16, the lower assembly 28 is provided with a wheel 30 having a vertical rotation axis and resting, by effect of the door weight, on a vertical surface 31 of rail 29 disposed in side by side relationship. A counter element 32 engages against the rail to avoid the door base moving away from the rail in a horizontal direction.

The lower guide assembly 28 is conveniently sized to enable a limited vertical sliding of the door while maintaining its guide function. The upper supporting and sliding assembly 13 can be provided with a known mechanism 33 (a screw and inclined-plane mechanism, for example) to enable height adjustment of the door. Since it is well apparent that at least two assemblies 33 (and possibly 28) are to be used on one and the same door, an independent adjustment in height of each assembly allows perpendicularity of the side edges of the door to be adjusted relative to the piece of furniture.

The adjustment mechanism is not herein further described or shown as it substantially belongs to the known art and therefore can be easily conceived by a person skilled in the art.

At this point it is apparent that the intended purposes have been achieved by providing a supporting and sliding system for piece of furniture doors of easy and safe use, capable of maintaining, under any condition, the door sliding rail in hooked engagement with the door, while at the same time enabling an easy disassembling, if required.

The further feature of an automatic fitting ensures hooking during assembling without particular operations being required by the installer. It is apparent that the system of the invention is provided with a safety mechanism against slipping off or derailment which is independent of the vertical-adjustment position, because the whole safety mechanism is integral with the wheel-carrying support and therefore is always in the same position with respect to the guide rail, independently of the vertical position of the door.

Obviously, the above description applying the innovative principles of the invention is given for purposes of illustration only and therefore must not be considered as a limitation of the scope of the invention as herein claimed.

For instance, proportions between the different parts, shapes of the hooking elements to the piece of furniture and the door, number of the sliding assemblies and rails can vary depending on the specific requirements.

What is claimed is:

1. A supporting and sliding system for a piece of furniture door comprising a supporting and sliding assembly to be fastened to the door and a rail on which the sliding assembly runs and which is designed to be secured to the piece of furniture, the sliding assembly comprising a grooved wheel resting and running on the rail, characterised in that along the rail there is an undercut under which a locking end of a constraint element projecting from the sliding assembly is positioned, which constraint element prevents the wheel from lifting from the rail to such an extent that derailment of the wheel from the rail should be caused.

2. A system as claimed in claim 1, wherein the constraint element is elastically movable outwardly of the undercut to be snap-fitted under the undercut when the wheel is set on the rail and prevent the wheel from moving away again from the rail.

3. A system as claimed in claim 2, wherein for enabling the snap-fitting movement the constraint element has an end in the form of a cam surface intended to run, when the wheel is set on the rail, on a corresponding cam surface provided on top of the undercut.

4. A system as claimed in claim 3, wherein the constraint element is made of a resilient foil laterally applied to the sliding assembly so as to have its end bent in the form of a hook projecting towards the rail to embody said locking end.

5. A system as claimed in claim 2, wherein the sliding assembly is provided with operating means for manual displacement of the constraint element outwardly of the undercut so as to enable the wheel to freely move away from the rail.

6. A system as claimed in claim 5, wherein the operating means comprises a lever movable between a rest position and a work position in which it moves the constraint element outwardly of the undercut.

7. A system as claimed in claim 3, wherein the operating means comprises a lever movable between a rest position and a work position in which it moves the constraint element outwardly of the undercut and the lever has a cam surface extending between the foil and a faced surface of the sliding assembly to push the constraint element outwardly of the undercut when said lever is moved to the work position.

8. A system as claimed in claim 7, wherein the constraint element has bending arms fastened to the sliding assembly and provided with shaped seatings designed to receive said cam surface of the lever.

9. A system as claimed in claim 8, wherein the lever is made in the form of a plate with a strip thereof disposed parallel to the rail to be received in said shaped seatings and embody said cam surface of the lever.

10. A system as claimed in claim 1, wherein it comprises a guide and slide assembly designed to be fastened to the door close to a lower side thereof so as to run along a second rail secured to the piece of furniture parallel to the first rail.
